(19) United States
(12) Patent Application Publication
(10) Pub. No.: US 2011/0058367 A1
(43) Pub. Date: Mar. 10, 2011

(54) Light Emitting Diode Tube

(75) Inventors: Fuh-Yuarn Shiau, Hsinchu City (TW); Chin-Chun Wu, Sihu Township (TW)

(73) Assignee: THERMOSHUTTLE CO., LTD., Tao Yuan (TW)

(21) Appl. No.: 12/772,382

(22) Filed: May 3, 2010

(30) Foreign Application Priority Data
Sep. 7, 2009 (TW) 98130012

(51) Int. Cl. F21V 29/00

(52) U.S. Cl. 362/218

(57) ABSTRACT

A LED light tube is disclosed. The light tube, along with the heat dissipation fins on it, is built as one piece. The heat dissipation fins are shaped like bats with wings extended out to have a well-defined center line, which helps create a better heat convection condition in the tube. The light tube also formed with two extended axis having a plurality of teeth formed thereon so as to provide the light tube having capability of angle adjustment about the axis of the light tube.

### BACKGROUND OF THE INVENTION

1. Field of the Invention

The present invention relates to a LED tube, particularly one designed to be used in/on street lamps or outdoor lighting devices.

2. Description of the Prior Art

Conventional street lamps are mostly either halogen or mercury lamps attached on the bent end of a lamppost. The lamp unit usually contains one or more than one halogen lamp or light emitting component, along with a reflector shield to add extra light to achieve desired illumination.

These conventional lamps, in general, consume more energy and expect shorter service life than LED lamps do.

LEDs are known to have more concentrated beams than do conventional light sources. But until recently, the luminosity of LEDs has been pretty limited, thus confining their use to such devices as signal lights, tail lights of vehicles, decorative lights, etc., which requires relatively low brightness. However, as a result of the invention of white LEDs and the dropping of manufacturing cost of LEDs, high lumen LEDs have found wider application, particularly in the present days when the reducing of energy consumption and carbon emission has become a major world issue. Governments around the world are encouraging people to replace their incandescent lighting with LED lighting. LED lighting is thus widely expected to become the mainstream of the market in the foreseeable future.

Also called cold-cathodes, LEDs are very different from conventional incandescent lights. They consume less energy and, with adequate heat dissipation, enjoy longer service life, even lasting tens of thousands of hours. By contrast, incandescent light bulbs usually last only about a thousand hours, while compact fluorescent bulbs, although lasting a bit longer, can but last up to a few thousand hours.

Prior art LED lighting devices are usually comprise a LED array having tens of LED chips disposed on a print circuit board (PC board). After being positioned and adjusted for light distribution, these integrated lighting devices will still leave some blind spots unlighted or inadequately lighted, which the user can do nothing about, for the light projection angles of these lighting devices cannot be adjusted after the devices are fixed in position. Furthermore, the entire LED lighting device has to be dismantled and re-assembled during any repair or maintenance processes, causing great troubles to the user.

In view of the above, the present invention has come up with an innovative new modulized LED tubes to be used in/on outdoor lighting devices.

### SUMMARY OF THE INVENTION

The present invention discloses a LED light tube along with the heat dissipation fins on it and built as one piece. The heat dissipation fins are shaped like bats with wings extended out to have a well-defined center line, which helps create a better heat convection condition in the tube. The light tube also formed with two extended axis having a plurality of teeth formed thereon so as to provide the light tube having capability of angle adjustment about the axis of the light tube.

Two adjustment spindles set on both ends of the hull with a plurality of gear racks set on its periphery to allow for the rotation of the spindles with arrange of angles when the light tube is seated on a seat of a LED lighting apparatus. The seat is designed with corresponding teeth.

After the tube is adjusted for desired light distribution through the adjustment spindles, it is then fastened with fastener sets. Besides, there is also a waterproof plug having a wiring outlet allowing for powercord connected with the PC board out plugged at one end of the light tube

### BRIEF DESCRIPTION OF THE DRAWINGS

The present invention will be more fully understood from the detailed description, which will be given hereinafter, with the aid of the illustrations below:

FIG. 1A shows the explosive view of the light tube and the LED PC board.

FIG. 1B shows the three-dimensional view of the back of the light tube hull.

FIG. 1C shows the three-dimensional view of the entire light tube.

FIG. 1D shows the side view of the light tube.

FIG. 1E shows the heat dissipation fins in mixed-size array (which is, one big size fin followed by one small size fin etc.,)

FIG. 1F shows the heat dissipation fins in another mixed-size array (which is, one big size fin followed by one medium size fin and one small size fin

FIG. 2 shows a side view of the light tube viewing from one adjustable spindle.

### DETAILED DESCRIPTION OF THE INVENTION

The following description will be illustrated with drawings. In the embodiment, the exemplary example is for illustrating convenience only not to limit the claim scope. For example, the permutation disposed of the LED chips on the LED PC board is not limited to the one illustrated in the drawing. It can be multiple chips in one row or multiple chips in multiple rows as any person skilled in the art can do. In one of the preferred embodiments, the LED chips are arranged at most in two rows, so that each LED chip in the tube can get better heat dissipation.

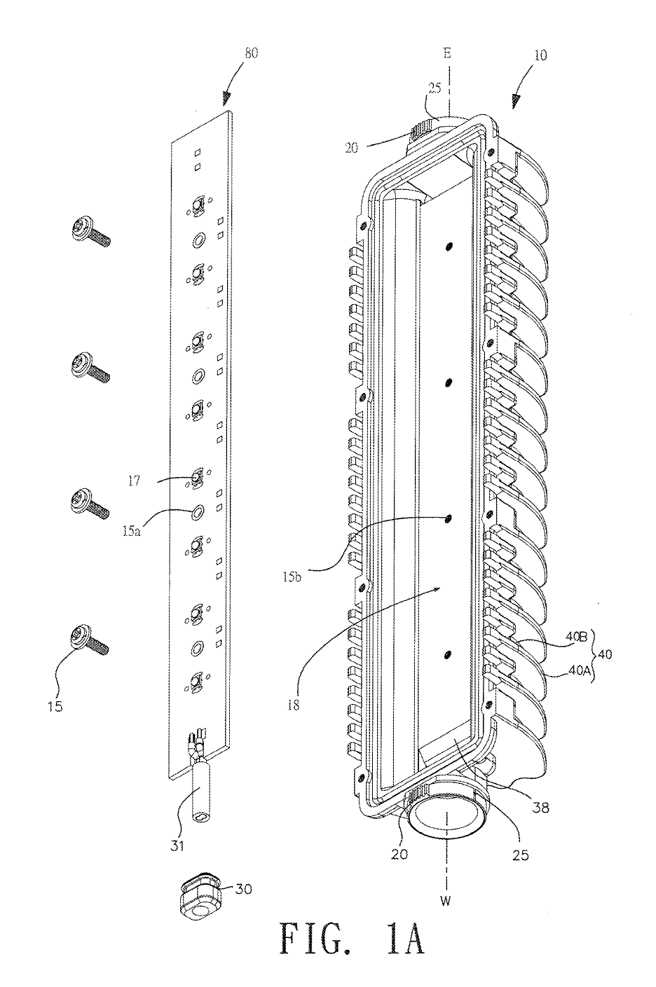

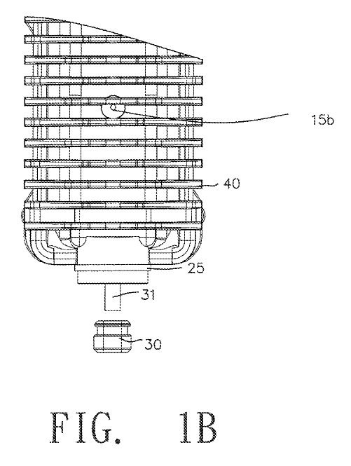

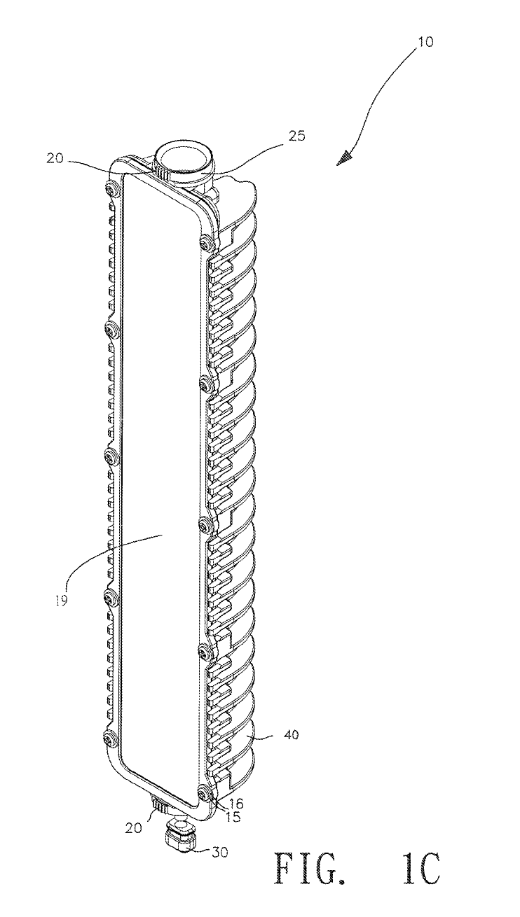

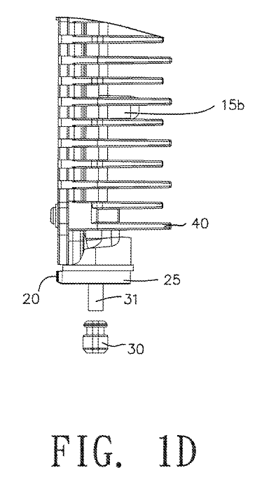

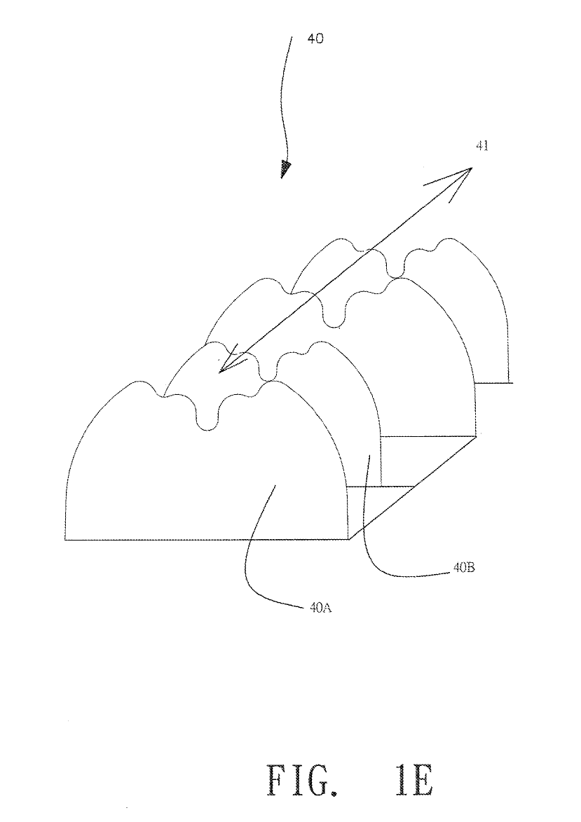

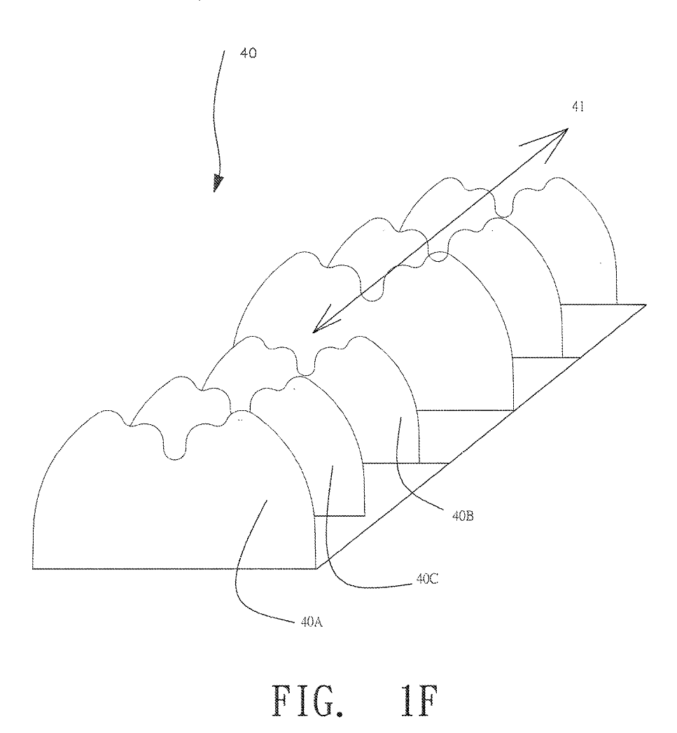

FIG. 1A shows the explosive view of the LED light tube hull 10 and the LED circuit board as disclosed by the present invention. The tube hull has a semi-cylindrical arch on the back of the light tube's hull 10. The back of the LED PC board is a metal plate in touch with the surface of the recessed platform 18. The metal plate is designed to simplify the process of mounting the LED PC board 80 onto the light tube hull 10. The LED PC board 80 is fastened by screws 15 through the holes 15a of the PC board 80 into the screw holes 15b on the platform 18. A plurality of bat-wing like spanned as heat dissipation fins 40, spaced lengthwise of the light tube, stand and on the tube vertically, as is shown on FIG. 1A. Please also refer to FIG. 1B, which shows the back of the light tube. One can see that, in FIG. 1B, the heat dissipation fins 40 sit on an arched (curved) surface. In another preferred embodiment, the heat dissipation fins 40 are not homogeneous in size, but may rather, for example, be interspaced with one bigger one 40A and one smaller one 40B, as is shown in FIGS. 1A, 1D, and 1E. This arrangement allows the space between two bigger-sized heat dissipation fins 40A to be comfortably larger, without being over-crowded. In still another preferred embodiment, there may be two smaller sized heat dissipation fins 40B positioned between two bigger-sized heat dissipation fins 40A, or, in yet another preferred embodiment, a middle-sized heat dissipation fins 40C and a smaller sized heat dissipation fins 40B positioned between two bigger-sized heat dissipation fins 40A. In other words, when the height of heat dissipation fins 40 are high and closed each other placing one or two small-sized heat dissipation fins 40B between two adjacent bigger-sized heat dissipation fins 40 will help ease the crowdedness of the heat dissipation fins 40. Another advantage of such arrangement is that it allows for better heat flow convection.

As is shown on FIG. 1A, the heat dissipation fins 40 as described in the above are all orienting toward the traversal direction of the light tube. An advantage of such a design is that it provides rainwater and dust with the shortest exit route. By contrast, prior art LED light tubes are designed with heat dissipation fins oriented toward the axial direction of the light tube, causing residual rainwater to be trapped and dust to be piled up on the grooves between the heat dissipation fins. Another disadvantage of such a design is that there can be potential difference between areas covered by dust and areas not covered by dust, causing galvanic corrosion on components and parts. However, the present invention's LED light tube, with its heat dissipation fins in formation vertical to the tube's axial direction, will solve the above problem.

On the platform 18 inside the hollow of the light tube hull there is a slanted portion 38, located near the adjustment spindle 25, to allow for the passage of the LED PC board 80's power cord 31. Please also note that the platform 18 and the heat dissipation fins 40 are both formed by casting or injection molded as one piece. No welding is needed.

As is mentioned before, the heat dissipation fins 40 stand in a traversal direction of the light tube can provide more total surface area than those of prior art, which the dissipation fins run parallel to the axial direction of the light tube in a given height of the fins and the same space between the fins. And larger heat dissipation area means better heat dissipation result, through either heat conduction or heat convection.

In one preferred embodiment, for example, the heat dissipation fins 40 are 0.2 mm thick and 50 mm wide and sit crosswise along the 300 mm long semi-cylindrical surface of a light tube, with a distance of 2.8 mm in between two adjacent fins 40. The heat dissipation effect of these fins in total is about several tens % higher than that of prior art fins which are 0.2 mm thick and 300 mm long, with a 2.8 mm distance in between two adjacent fins

According to Newton's law of heat convection Q=hA(Tₛ−T_{f}), the heat convection coefficient h is affected by the geometry of the contact surface, the flowing state of the fluid, the physical properties of the fluid, etc., That is to say, the coefficient h is related to laminar flow, transition flow, or vortex flow. Herein the fluid is air, and the vortex flow can provide most main part of the heat conviction, the laminar flow is the next important one. The arrangement of the dissipation fins on a curve back can provide more efficiency than the longwise dissipation fines or the dissipation fins as the present invention but stand in plain back of the hull 10.

To an outdoor street lamp, the cool night air in the surrounding can serve as the heat convection provider. Thus, to the lamp, heat convection is more important than heat conduction. The key factor to heat dissipation is to have the air flow passing through the light tube and process the heat convection sufficiently with the heat dissipation fins. The heat dissipation fins intermixing with middle and small sized fines will allow the ambient air to flow through the heat dissipation fins 40A, 40B of the light tube 10 much more easily, although the heat dissipation surface areas of the smaller fins may some what decrease the surface areas. Furthermore, the shape of the heat dissipation fins 40 are just like that of a pair of extended bat-wings, the lower central line can assistant better heat exchange, due to the airflow easier to circulate among each heat dissipation fins 40, resulting in increase the I heat convection effect.

According to data obtained from experiments, the present invention's light tube can effectively lower the temperature of its LED chips, particularly when there is breeze in the surrounding air. Please refer to the data obtained from experiments in Table 1.

| | |
|---|---|
| 1. heat dissipation paste: | ShinEtsu X-23-7762 |
| 2. term to be tested: | 2-1. LED Solder Point (Tsp) |
| | 2-2. LED Fin Point (Tc) |
| 3. ambient temperature | 24~25° C. |
| & air flow: | No wind |
| 4. tesing instrument: | Thermometer TES1314 |
| | DC power supply GPS-3030D |
| 5. conndition: | 17 V/1.4 A/23.8 W |
| | LED upward |
| | The LED module are 3 cm |
| | above the ground |

| | | On LED PC | On the rear of | |
|---|---|---|---|---|
| | | board (A) | the PC board (B) | |
| Time | | Solder P T(° C.) | Fin P T(° C.) | Δ AB |
| 20 | s | 29.7 | 27.1 | 2.6 |
| 40 | s | 30.3 | 27.7 | 2.6 |
| 60 | s | 30.9 | 28.1 | 2.8 |
| 80 | s | 31.6 | 28.7 | 2.9 |
| 100 | s | 32.0 | 29.4 | 2.6 |
| 120 | s | 32.6 | 29.9 | 2.7 |
| 140 | s | 33.1 | 30.3 | 2.8 |
| 160 | s | 33.4 | 30.7 | 2.7 |
| 180 | s | 33.9 | 31.1 | 2.8 |
| 200 | s | 34.4 | 31.6 | 2.8 |
| 220 | s | 34.8 | 31.9 | 2.9 |
| 240 | s | 35.2 | 32.2 | 3.0 |
| 8 | min | 38.6 | 35.6 | 3.0 |
| 12 | min | 41.1 | 37.9 | 3.2 |
| 16 | min | 42.7 | 39.8 | 2.9 |
| 20 | min | 43.5 | 40.4 | 3.1 |
| 24 | min | 44.4 | 41.1 | 3.3 |
| 30 | min | 44.6 | 41.5 | 3.1 |

Remark:
1. temperature difference is about 2.6~3.3° C.
2. Tj is 44.6 + (9*2.4) = 66.2° C. after 30 min, which is lower than 80° C. suggested by CREE.)
3. according to CREE long term life test, the Ta [symbol] Tb are 45° C., thus the light decay is estimated to be 5% after 7000 hrs light on.

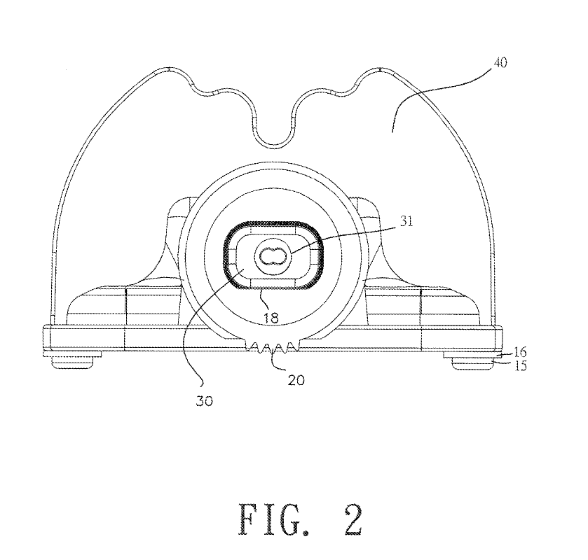

Please also refer to FIG. 1A and FIG. 2. On each of the two ends of the light tube hull 10, there is an adjustment spindle 25. One of the two adjustment spindles 25 is designed with a rectangular hole (with rounded/filleted corners). The rectangular hole is then plugged with a water proof seal 30, which have a hole in the center, through which a power line goes out. The end (of the adjustment spindle 25) that faces toward the ground comes with a plurality of gear racks 20. These racks 20 work with the gear racks of the lighting device's light tube seat to provide for the adjustment of the light tube's light projection angle. After the adjustment of the light tube 10, the tube is locked into position with screws and fasteners.

The present invention has the following advantages:
1. The heat dissipation fins and the light tube hull are built as one piece.
2. The heat dissipation fins are not tubular bodies parallel to the axial line of the tube, but rather, they stand vertically on the semi-cylindrical body of the hull, making it easy for residual rain water and dust to be washed away, while in the same time providing for better heat convection.
3. Each heat dissipation fin spreads out like the wings of a bat; the lower central line of the fin facilitating better heat exchange.
4. The array of the heat dissipation fins are mixed with various size fins, providing better heat exchange environment than an array made of equal size fins.
5. The light tube can be adjusted for ideal light projection angle through the matching of the gears on the adjustment spindle with the tooth grooves on the light tube seat.
6. The light tube is standardized and modulized just like conventional light bulbs. To repair an out-of-service lighting device, one can just replace the mal-functioned light tube.

As is understood by a person skilled in the art, the foregoing preferred embodiment of the present invention is an illustration, rather than a limiting description, of the present invention. It is intended to cover various modifications and similar arrangements included within the spirit and scope of the appended claims, the scope of which should be accorded the broadest interpretation so as to encompass all such modifications and similar structures.

What is claimed is:

1. An LED light tube, comprising:
a hull with a semi-cylindrical body formed with a recessed platform inside;
a PC board with LED chips mounted on said platform;
a plurality of heat dissipation fins with various sized interposed standing vertically on said tube and oriented in a transversal direction of said light tube;
two adjustment spindles located on two ends of hull, with a plurality of gear racks around said adjustment spindles to allow for said adjustment spindles rotated within a range of angles, when said light tube is positioned on a seat with corresponding gear.

2. The LED light tube as in claim 1, wherein said heat dissipation fin is shaped like a bat extending its wing, with a central line of said heat dissipation fin lower than said wings.

3. The LED light tube as in claim 1, further comprising a water proof seal having a power outlet hole to allow a powerc ord of said PC board connected through, and said water proof seal plugged on a hole located at a first end of said adjustment spindles.

4. The LED light tube as in claim 3, wherein said platform further comprising a slated portion at a position closed to said first end.

5. The LED light tube as in claim 1, wherein said plurality of gear racks are formed on the circular shaped end of said adjustment spindles/

6. The LED light tube as in claim 1, wherein said heat dissipation fins are arranged parallel to each other and spaced alternatively in accordance with one big size fin followed by either one small size fin, or two small size fins.
